(19) United States
(12) Patent Application Publication
(10) Pub. No.: US 2011/0168430 A1
(43) Pub. Date: Jul. 14, 2011

(54) METHOD OF FORMING METAL WIRING AND ELECTRONIC PART INCLUDING METAL WIRING

(76) Inventor: Takuya Hata, Saitama (JP)

(21) Appl. No.: 13/063,588

(22) PCT Filed: Sep. 11, 2008
(86) PCT No.: PCT/JP2008/066472

§ 371 Date: Mar. 11, 2011

(51) Int. Cl. H01B 5/00; B05D 5/12

(52) U.S. Cl. 174/126.1; 427/99.5

(57) ABSTRACT

[Problems] To provide a method of forming metal wiring capable of forming metal wiring of ultrathin film and an electronic part including the metal wiring of ultrathin film.

[Solving Means] A compound having an ethoxysilane group or a methoxysilane group and a thiol group is used. A number of metal particles each having a surface previously covered with the compound by chemical bond of the thiol group of the compound are prepared. The metal particles are fixed to a base surface by chemically bonding a silanol group produced by hydrolyzing the ethoxysilane group or the methoxysilane group to the base surface, the metal wiring being to be formed on the base surface. The metal wiring may be formed only from the metal particles, or electroless plating is performed by using the metal particles as a catalyst to thickly provide the same type or a different type of metal.

### TECHNICAL FIELD

The present invention relates to a method of forming metal wiring through the use of a compound having an ethoxysilane group or a methoxysilane group and a thiol group, and to an electronic part including the metal wiring.

### BACKGROUND ART

On a printed board or the like mounted in electronic equipment such as a display panel, conductive elements including wiring, contacts, and electrodes are formed from metal materials. The conductive elements such as the wiring have conventionally been provided by forming a metal thin film through vapor deposition or sputtering in a vacuum apparatus and then patterning the film with a photolithographic technology and an etching technology. The method as described above, however, requires the large-scale vacuum apparatus, and thus plating has been used to form the metal thin film in recent years. Among others, electroless plating capable of high-precision work is receiving attention as a technique of forming finer and complicated metal wiring.

As typified by liquid crystal displays and organic EL displays, display panels have been increasingly reduced in thickness in recent years, and accordingly, there has been a demand to reduce the thickness of electronic parts mounted on the panels (for example, circuit boards and electronic components such as transistors and capacitors). In addition to the display panels, a reduction in thickness has been realized in a number of types of electronic equipment such as computers and cellular phones. Thus, there has been an increasing demand for the wiring, the contact, the electrode, and other conductive elements formed in the electronic part to have not only a finer size and a complicated structure but also a thinner film.

Gold (Au) having excellent conductivity and durability is one of the materials of the metal wiring. It is difficult to plate a substrate directly with Au, and conventionally, two-stage plating has typically been performed in which a base metal layer of Ni, Cu, or the like is formed on a substrate through plating, the surface of the base metal is substituted by Au, and then Au is thickly provided through plating by using the catalysis of Au. In this case, the base metal is not completely substituted and the result is the double-layer structure including the base metal and Au, so that there is a limit to the formation of a thinner film and the process is complicated. Consequently, to satisfy the need to realize a thinner film, it has been necessary to develop a novel technology allowing the formation of single-layer wiring of ultrathin film.

Techniques of forming Au wiring without providing the base metal of Ni, Cu, or the like include a known technique in which an organic compound is used to chemically bond Pd and Sn serving as catalysts onto a substrate and the catalysis of Pd and Sn is used to grow an Au thin film through plating (see, for example, Patent Documents 1 and 2).

Patent Document 1 has disclosed a method of forming a gate electrode of an organic thin film transistor. In the method, a resin substrate is immersed in an alkoxysilylalkylenetriazinedithiol (TASTD) solution and then heated and dried to cause the reaction of an OH group on the substrate and an alkoxysilyl group of TASTD to provide a dithiol triazinyl group (FIG. 1) on the substrate. In addition, a particular site is irradiated with light with a mask method or a reduction projection method to form a surface having the selectivity of catalyst support on the substrate. Then, after the substrate is immersed in a Pd and Sn salt aqueous solution to support Pd and Sn, electroless plating is performed to grow Au on the catalyst support surface to form the gate electrode.

Patent Document 2 reported by the same applicant as that of Patent Document 1 has made description in which triazinedithiol having an alkoxysilane group is used to form a surface having the selectivity of catalyst support on the surface of a solid body, and the solid body is immersed in a Pd catalyst solution to support Pd and then is immersed in a reducing copper aqueous solution for plastic plating to precipitate copper.

In the techniques described in Patent Documents 1 and 2, after the catalyst support surface made from the dithiol triazinyl group is formed, the substrate is immersed in the Pd salt solution containing dissolved Pd serving as the catalyst to support Pd. No problems occur when the Pd salt solution is used as the catalyst solution. However, problems may become apparent when a catalyst solution containing dispersed metal particles is used. Specifically, when a solution containing dispersed Au particles acting as an autocatalyst is used as a catalyst solution in order to realize an Au single-layer wiring of ultrathin film, the particles may be flocculated in the catalyst solution to prevent the Au particles from being supported uniformly on the substrate.

However, a technology of suppressing the flocculation of particles has conventionally been known in a method of supporting metal particles serving as a catalyst on a substrate (see, for example Patent Document 3).

Patent Document 3 has disclosed a method in which noble metal particles serving as a catalyst are supported on a substrate and electroplating is performed to form a circuit. In the method, patterns are formed on a substrate in both of a hydrophilic portion and a water-repellent portion through patterning with a silane coupling agent and the substrate is immersed in a catalyst solution containing the dispersed noble metal particles serving as the catalyst such that the metal particles are supported in the hydrophilic portion on the substrate. In this case, the flocculation of the noble metal particles is suppressed by using the catalyst solution containing a thiol compound and the noble metal particles.

When the surface of the noble metal particles is covered with the thiol compound disclosed in Patent Document 3, however, the flocculation of the particles is suppressed, and on the other hand, absorptive activity onto the substrate may be limited. The catalyst may not be supported sufficiently, or even when it is supported, it may come off easily. In addition, since the noble metal particles are physically absorbed by the substrate, it is assumed that the adhesion of the metal film to the substrate is low.

[Patent Document 1] Japanese Patent Laid-Open No. 2007-149711

[Patent Document 2] Japanese Patent Laid-Open No. 2007-134525

[Patent Document 3] Japanese Patent Laid-Open No. 2007-84850

### DISCLOSURE OF THE INVENTION

### Problems to be Solved by the Invention

The problems to be solved by the present invention include the abovementioned ones as examples. It is thus an object of the present invention to provide a method of forming metal wiring capable of forming single-layer wiring of ultrathin film, and an electronic part including the metal wiring formed of such single-layer wiring of ultrathin film, by way of example.

It is another object of the present invention to provide a method of forming metal wiring in which it is possible to suppress the flocculation of metal particles used as a catalyst or metal particles forming the wiring and to promote the bond of the metal particles to a substrate, and an electronic part manufactured by the method, by way of example.

### Means for Solving the Problems

As described in claim 1, a method of forming metal wiring according to the present invention is a method of forming metal wiring of thin film shape through the use of a compound having an ethoxysilane group or a methoxysilane group and a thiol group, characterized by including the step of preparing a number of metal particles each having a surface previously covered with the compound by chemical bond of the thiol group of the compound, and fixing the metal particles to a base surface by chemically bonding a silanol group produced by hydrolyzing the ethoxysilane group or the methoxysilane group to the base surface, the metal wiring being to be formed on the base surface.

As described in claim 10, electronic equipment according to the present invention is characterized by including the metal wiring formed by the method according to any one of claims 1 to 9.

### BRIEF DESCRIPTION OF DRAWINGS

FIG. 1 A diagram showing the outlines of a method of forming metal wiring according to an embodiment of the present invention.

FIG. 2 A diagram showing steps in the method of forming metal wiring according to the embodiment of the present invention.

### DESCRIPTION OF REFERENCE NUMERALS

M Metal Particles
R COVERING COMPOUND
1 SUBSTRATE
2 METAL WIRING

### BEST MODE FOR CARRYING OUT THE INVENTION

A preferable embodiment according to a method of forming metal wiring of the present invention will hereinafter be described in detail with reference to the accompanying drawings. However, the technical scope of the present invention is not limitedly interpreted by the embodiment described below.

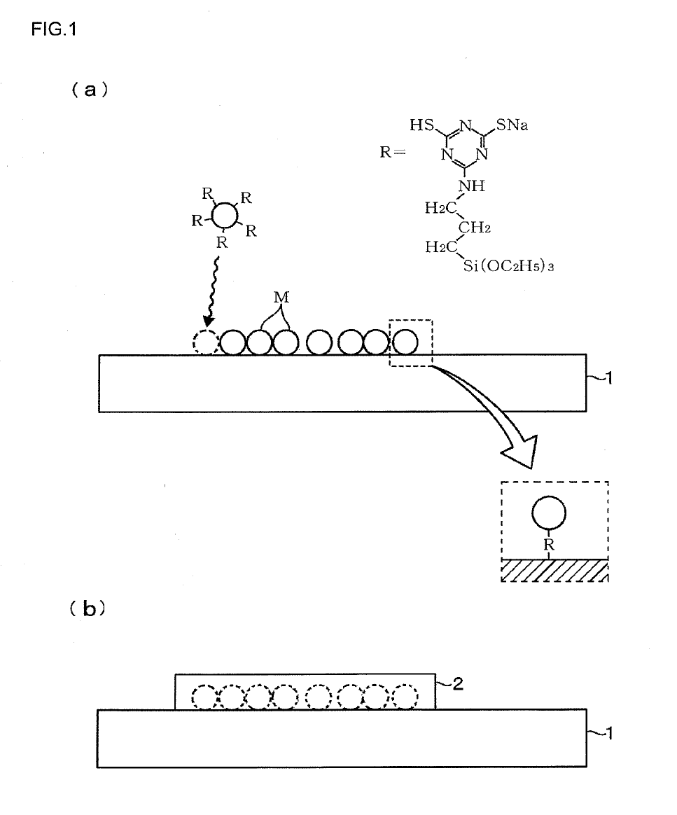

First, the outlines of the method of forming metal wiring according to the present embodiment will be described. As schematically shown in FIG. 1(a), the method of forming metal wiring according to the present embodiment includes a first step in which a compound R having an ethoxysilane group (—SiOC₂H₅) or a methoxysilane group (—SiOCH₃) and a thiol group (—SH) is used, the thiol group is chemically bonded to the surfaces of metal particles M to prepare a solution in which the metal particles M having the surfaces previously covered with the compound R are dispersed, and then a substrate 1 on which the metal wiring is to be formed, is immersed in the dispersion solution or the dispersion solution is applied onto the substrate 1 to chemically bond the ethoxysilane group or the methoxysilane group of the compound R to the substrate, thereby chemically fixing the metal particles M to the surface of the substrate 1. More particularly, a silanol group produced by hydrolyzing the ethoxysilane group or the methoxysilane group is chemically bonded to the substrate 1. It should be understood that the term “metal wiring” used in the specification not only means wiring but also encompasses wiring, contacts, electrodes, and any other conductive elements made from metal materials and formed in a thin film shape.

As schematically shown in FIG. 1(b), the metal particles M chemically bonded to the surface of the substrate as described above can be used as a catalyst of plating treatment (preferably, electroless plating) performed at a second step. The substrate 1 is immersed in a plating bath to thickly provide the same type of metal as that of the metal particles M to allow the formation of a single-layer metal wiring 2 of ultrathin film having a necessary thickness (that is, necessary conductive property).

The type of the metal grown on the substrate through the plating treatment may not be necessarily the same type as that of the metal particles, and a different type of metal from that of the metal particles may be grown. In addition, in the present embodiment, the plating treatment at the second step may be eliminated and the metal wiring may be formed only from the metal particles bonded to the surface of the substrate by adjusting one or more of the size, the shape, and the concentration of the metal particles in the dispersion solution. In this case, the advantage is provided in that the plating treatment can be omitted to simplify the process. It should be noted that the metal particles may be sintered by performing heating treatment in order to improve the strength of the wiring.

The material of the substrate is not limited particularly in the present embodiment. Examples thereof include a glass substrate (preferably, a non-alkali glass substrate), a silicon substrate, a ceramic substrate, or a resin substrate made from a resin material such as polyimide resin, epoxy resin, polycarbonate resin, polyethylene terephthalate (PET), polyethylene naphthalate (PEN), polyether sulfone (PES), polyolefin (PO), and liquid crystal polymer. In this case, it is preferable to use a substrate made from a material having a hydroxyl group (OH group) and/or a carbonyl group (COOH group) on a surface or to use a substrate subjected to surface treatment to form (or increase the amount of) the OH group and/or the COOH group thereon. When the OH group and/or the COOH group is present on the substrate surface, the reaction of the silanol group produced from the ethoxysilane group or the methoxysilane group and the OH group and/or the COOH group is promoted, and the metal particles can be stably fixed to the substrate through the bond which can be represented by the chemical formula —Si—O— and/or —Si—OOC—. Examples of the surface treatment for forming the OH group include UV ozone treatment, oxygen plasma treatment, alkaline cleaning, and boiling treatment. Examples of the surface treatment for forming the COOH group include UV ozone treatment, oxygen plasma treatment, and corona discharge treatment. The resin substrate is preferably subjected to treatment so that the COOH group is formed thereon. Since the surface treatments mentioned as examples are known, the description of the detailed procedures, conditions and the like thereof is omitted in the specification. It should be noted that the abovementioned surface treatment is not necessarily needed to be performed over the entire surface of the substrate and may be performed only in the region in which the metal wiring is to be formed.

In the present embodiment, the surface (base surface) on which the metal wiring is to be formed is not limited to the surface of the substrate such as a printed board, and may be a surface such as a surface of a substrate of an electronic component such as an inorganic transistor, an organic transistor, an organic EL element, an inorganic EL element, a capacitor, an inorganic solar battery, and an organic solar battery, or a surface of an interlayer insulating layer, an organic semiconductor layer, a gate insulating layer, or an inorganic semiconductor layer in an organic/inorganic TFT (Thin Film Transistor), for example.

The desired patterning of the metal wiring can be realized by performing chemical or physical masking treatment in the region in which the metal wiring is not to be formed such that the metal particles are selectively bonded only to the region in which the metal wiring is to be formed. Examples of the chemical masking treatment include a method using a coupling agent, later described in detail. Examples of the physical masking treatment include a method in which a photoresist is applied onto the substrate, and exposure or graphic-drawing and development are performed to form a patterned resist mask, or a mask made of an inorganic substance is formed on the substrate. It should be noted that the abovementioned masking treatment may be eliminated and that the metal thin film may be formed through plating and then be patterned with the photolithography technology and the etching technology as in the related art.

It is only required that the metal particles should be formed from a metal having conductivity and/or catalysis, and the type of the metal is not limited particularly in the present embodiment. Preferable examples of the metal having the catalysis include one selected from gold (Au), nickel (Ni), cobalt (Co), iron (Fe), copper (Cu), silver (Ag), rhodium (Rh), palladium (Pd), and platinum (Pt) which are metals having autocatalysis, or an alloy of two or more selected therefrom.

The size and/or the shape of the metal particles is not limited as long as the particles can be dispersed in the solution. However, nanoparticles or microparticles are preferably used in view of the dispersion property in the solution. For example, when the metal particles are used as the catalyst in the plating treatment, extremely small particles having an average particle diameter of approximately 1 nm to 10 nm are preferably used for the reason of the ability to form fine metal wiring. On the other hand, when the metal wiring is formed only from the metal particles, particles having an average particle diameter of approximately 100 to 500 nm are preferably used for ensuring the necessary thickness.

A compound having both of the ethoxysilane group (—SiOC₂H₅) or the methoxysilane group (—SiOCH₃) and the thiol group (—SH) is used as the compound which covers the surfaces of the metal particles described above. Preferably, a triethoxysilane group (—Si(OC₂H₅)₃) or a trimethoxysilane group (—Si(OCH₃)₃) is used. Either of an organic substrate or an inorganic substrate can be used as long as it has both of the ethoxysilane group or the methoxysilane group and the thiol group as described above. An example of the compound is a thiol compound derivative provided by introducing the ethoxysilane group or the methoxysilane group into a thiol compound. An example thereof is a triazinethiol derivative which can be represented by chemical formulas [2] below. The compound may be one of chemical formulas (a) and (b) or may include both. Among others, a triazinedithiol derivative which can be represented by a chemical formula [3] below is preferable. While the following chemical formula shows the example of 1,2,3-triazine, 1,2,4-triazine or 1,3,5-triazine which is an isomer can be used. However, the present embodiment is not limited to the triazinethiol derivative, and it is possible to use a mercaptopropyltrimethoxysilane (MPS) which is a thiol-containing silane coupling agent, or the like. In addition, the abovementioned thiol compound derivative, mercaptopropyltrimethoxysilane (MPS) and the like may be obtained from commercially available ones, or may be manufactured by using a known technology.

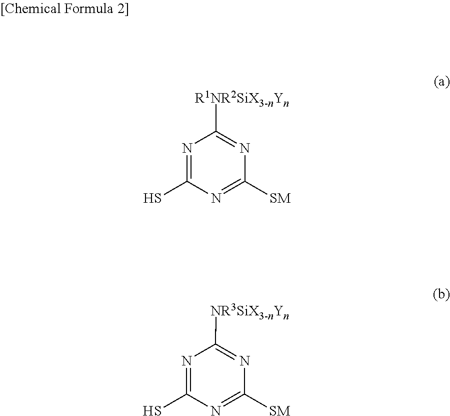

[In the formulas, Y represents an ethoxy group (C₂H₅O—) or a methoxy group (CH₃O—), X represents CH₃—, C₂H₅—, n-C₃H₇—, i-C₃H₇—, n-C₄H₉—, i-C₄H₉—, or t-C₄H₉—, M represents an alkali metal such as Na, Li, K, or Ce, R¹ represents H—, CH₃—, C₂H₅—, n-C₃H₇—, CH₂═CHCH₂—, n-C₄H₉—, C₆H₅—, or C₆H₁₃—, R² represents —CH₂CH₂—, —CH₂CH₂CH₂—, —CH₂CH₂CH₂CH₂CH₂CH₂—, —CH₂CH₂SCH₂CH₂—, —CH₂CH₂NHCH₂CH₂CH₂—, —CH₂CH₂OCONHCH₂CH₂CH₂—, or —CH₂CH₂NHCONHCH₂CH₂CH₂, R³ represents —(CH₂CH₂)₂N—CH₂CH₂CH₂—, or —(CH₂CH₂)₂CHOCONHCH₂CH₂CH₂—, and n represents an integer from one to three]

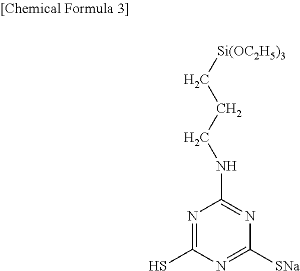

As the solvent for dispersing the abovementioned metal particles, any solvent may be used as long as the compound covering the surfaces of the metal particles can be dissolved and the metal particles are dispersed without being dissolved. An example of the solvent when the triazinethiol derivative is used is ethanol. The concentrations of the metal particles and the covering compound can be adjusted as appropriate depending on the types of the selected metal and compound. Preferably, the concentration of the metal particles ranges from 1 wt % to 5 wt %, and the concentration of the compound ranges from 0.1 wt % to 2 wt %.

In the present embodiment, the metal particles and the covering compound are added to and stirred in the solvent to cause the reaction of both, so that the thiol group is bonded to the surfaces of the metal particles. In this case, the hydrolytic reaction of the ethoxysilane group or the methoxysilane group proceeds in the solvent to produce the silanol group (—SiOH). Thus, the solvent preferably contains water for the hydrolytic reaction. For example, in the case of the triethoxysilane group (—Si(OC₂H₅)₃), —Si(OH)₃ is produced. In the present embodiment, the metal particles having the surfaces covered with the compound can be provided through such a simple process. It should be noted that treatment such as heating and stirring may be performed as appropriate in order to promote the reaction. In addition, instead of the method of adding the metal particles, a metal salt serving as the material of the metal particles may be dissolved in a solvent and reduction treatment may be performed to precipitate metal, thereby producing the metal particles.

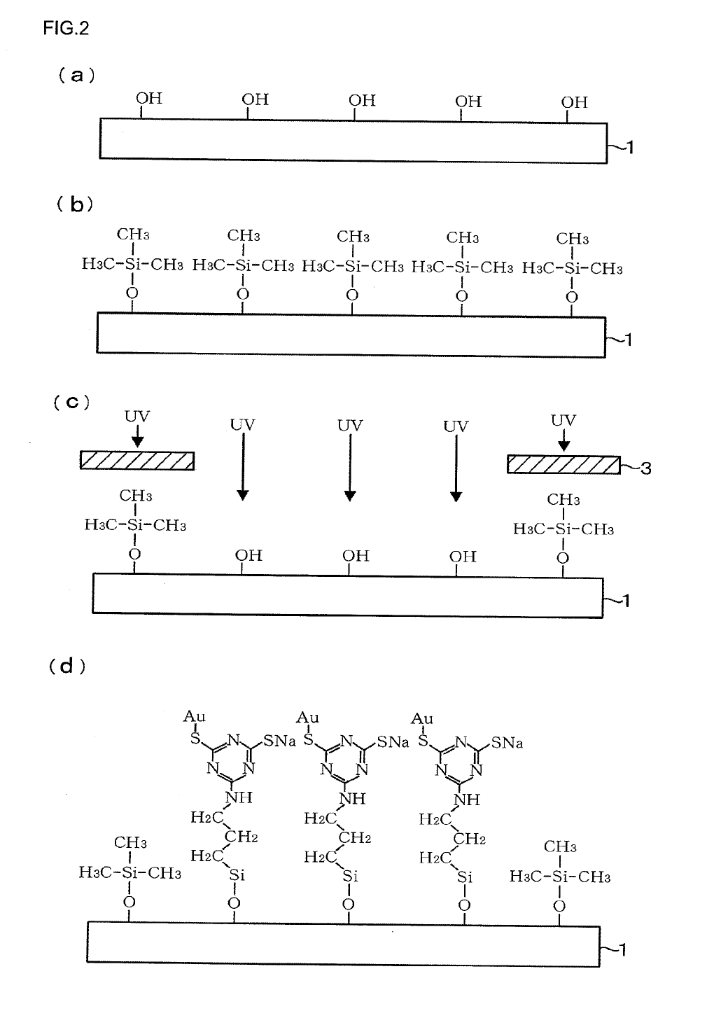

After the solution in which the metal particles having the surfaces covered with the compound are dispersed is prepared as described above, the step of forming the metal wiring using that dispersion solution is performed. FIG. 2 is a process diagram schematically showing a preferable example of the process of forming the metal wiring. FIG. 2 shows an example in which the triethoxysilane derivative shown in the chemical formula [3] is prepared and Au single-layer wiring is formed on the non-alkali glass substrate for the convenience of description. However, the present invention is not limited thereto as described already. In addition, while FIG. 2 shows the example in which the metal wiring is formed only on the upper surface of the substrate for the convenience of drawing, the metal wiring may be formed on both of the upper surface and the lower surface of the substrate in accordance with the following method.

First, the glass substrate 1 is cleaned in order to remove soil or fat, for example. Then, the surface treatment such as UV ozone treatment is performed to form (or increase the amount of) the OH group (FIG. 2(a)).

Subsequently, a known organic silane compound is used to perform silane coupling treatment on the surface of the substrate 1. Examples of the organic silane compound used as the silane coupling agent include organic disilazane such as hexamethyldisilazane (HMDS), organic chlorosilane such as octadecyltrichlorosilane (OTS), and alkoxysilane. FIG. 2(b) shows an example in which the silane coupling treatment is performed by using the HMDS to form a Self Assembled Monolayer (SAM film) of trimethylsilanol through the reaction with the OH group formed on the surface of the substrate 1. Such silane coupling treatment is performed with liquid phase treatment of applying and drying a solution containing the silane coupling agent or vapor phase treatment of exposing the substrate into the vapor atmosphere of the silane coupling agent and performing baking at a predetermined temperature, by way of example.

After the silane coupling treatment is performed as described above, ultraviolet rays are applied to the region in which the metal wiring is to be formed with a photomask 3 interposed (FIG. 2(c)). An excimer UV lamp, a mercury lamp, a xenon lamp, an ultraviolet LED or the like can be used as the light source. The application of the ultraviolet rays decomposes and removes the SAM film in the region irradiated with the ultraviolet rays. As a result, the region in which the metal wiring is to be formed is exposed, while the SAM film remains in the region in which the metal wiring is not to be formed. It is only required that the ultraviolet rays may be applied to the region in which the metal wiring is to be formed, and the application of the ultraviolet rays may be performed with a known graphic-drawing technology instead of the exposure to light with the photomask interposed.

Then, the substrate 1 is immersed in the dispersion solution containing the Au particles covered with the triazinedithiol derivative, or the dispersion solution is applied onto the substrate, thereby selectively bonding the Au particles covered with the triazinedithiol derivative to the region exposed after the SAM film is decomposed and removed (FIG. 2(d)). At this point, it is preferable that the dispersion solution in which the substrate is immersed is heated to a temperature of 50 to 70° C. and that the immersion period is set to 1 to 3 hours in order to promote the reaction of the bond of the silanol group produced by the hydrolysis of the ethoxysilane group of the triazinedithiol derivative to the substrate 1.

Subsequently, the catalyst of the Au particles bonded to the substrate 1 is utilized to thickly provide Au through the electroless plating to form the Au single-layer wiring 2 on the substrate 1 (see FIG. 1(b)). The thickness of the wiring 2 can be controlled by adjusting the time and the temperature of the plating, the composition of the plating solution and the like, for example. The thickness preferably ranges from 30 to 200 nm in order to ensure the necessary conductive property and to satisfy the need to realize a thinner film.

The electroless plating solution for thickly providing Au contains a metal salt including Au, a reducing agent, and a reaction auxiliary agent added as required. Specific examples include gold sodium sulfite such as Na₃Au(SO₃)₂ and gold potassium sulfite as a gold complex salt of sulfite, sodium thiosulfate such as Na₃Au(S₂O₃)₂ and potassium thiosulfate as a gold complex of thiosulfate, sodium chloroaurate and potassium chloroaurate as a salt of chloroauric acid, thiourea gold hydrochloride and thiourea gold perchlorate as a thiourea gold complex salt, and gold sodium thiomalate and gold potassium thiomalate as a gold complex salt of thiomalic acid. These gold sources may be used alone or in a combination of two or more types simultaneously. For example, gold potassium sulfite and gold sodium thiosulfate can be used. For the reducing agent, it is possible to use a general reducing agent exerting catalytic activity to gold. Examples thereof include ascorbate such as sodium ascorbate or hydroxylamine and a salt of hydroxylamine such as hydroxylamine hydrochloride and hydroxylamine sulfate or a hydroxylamine derivative such as hydroxilamine-O-sulfonic acid or hydrazine, an amine borane compound such as dimethylamineborane, a boron hydride compound such as sodium borohydride, sugars such as glucose, and hypophosphite. For the reaction auxiliary agent, an inorganic acid such as sulfuric acid, hydrochloric acid, and phosphoric acid, and a hydroxide salt such as sodium hydroxide and potassium hydroxide are used as a pH controlling agent, polyethylene glycol or the like is used as a grain shape controlling agent, and examples of a brightening agent include thallium, copper, antimony, and lead. Preferably, the dispersion solution in which the substrate is immersed is heated to a temperature of 40° C. to 70° C. and the immersion period is set to 10 minutes to 1 hour in order to promote the precipitation of Au.

According to the present embodiment described above, the metal particles having the surfaces covered with the thiol compound having the ethoxysilane group or the methoxysilane group are prepared and previously provided, and the metal particles can be chemically fixed to the substrate surface by chemically bonding the silanol group produced by hydrolyzing the ethoxysilane group or the methoxysilane group to the substrate surface. While the metal particles are easily flocculated in general due to high surface activity, the previous covering thereof with the thiol compound reduces the surface activity to suppress the flocculation. However, the covering with the thiol compound also leads to reduced absorption to the substrate surface, so that the thiol compound having the ethoxysilane group or the methoxysilane group is used in the present embodiment and the silanol group is produced by the hydrolysis to promote the chemical bond to the substrate surface. As a result, many of the metal particles can be sufficiently and uniformly fixed to the substrate surface. In addition, the metal particles chemically bonded to the substrate surface through the thiol compound have high adhesion to the substrate as compared with the case where they are merely physically absorbed.

Since the metal particles are used as the catalyst and the electroless plating is performed to thickly provide the same type of the metal, the single-layer metal wiring of ultrathin film can be formed, and the formed metal wiring can have the high adhesion to the substrate. The present inventors have recognized that, for example in the case of Au single-layer wiring, the film can be reduced in thickness to approximately 30 nm which was difficult to realize in the related art. The advantage can also be provided when a different type of metal is thickly provided through the electroless plating.

In addition, according to the present embodiment, the SAM film or the like patterned on the substrate is used to perform the masking to selectively attach the metal particles only to the portion in which the metal wiring is to be formed, so that the metal wiring having the desired pattern can be formed. Since the previous masking causes the metal particles to be attached only to the required portion in this manner, it is possible to prevent any fault such as a leakage of current due to attachment of the metal particles to an unnecessary portion, and the manufacture cost can be reduced.

While one embodiment of the present invention has been described as an example, it is apparent to those skilled in the art that many modifications and variations can be made without departing from the spirit or scope of the present invention, and those modifications and variations are encompassed by the technical scope of the present invention.

1. A method of forming metal wiring of thin film shape through the use of a compound having an ethoxysilane group or a methoxysilane group and a thiol group, comprising:
preparing a number of metal particles each having a surface previously covered with the compound by chemical bond of the thiol group of the compound, and fixing the metal particles to a base surface by chemically bonding a silanol group produced by hydrolyzing the ethoxysilane group or the methoxysilane group to the base surface, the metal wiring being to be formed on the base surface,
wherein the compound includes a triazinedithiol derivative representable by a chemical formula (a) and/or a chemical formula (b) below: 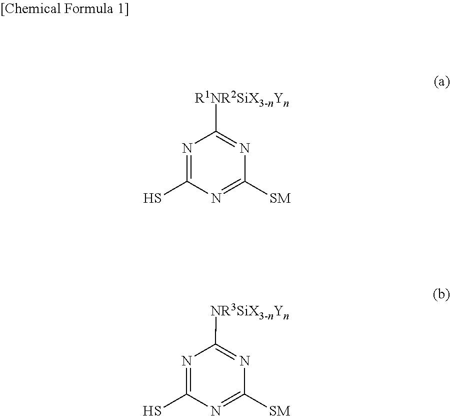
[In the formulas, Y represents an ethoxy group (C₂H₅O—) or a methoxy group (CH₃O—), X represents CH₃—, C₂H₅—, n-C₃H₇—, i-C₃H₇—, n-C₄H₉—, i-C₄H₉—, or t-C₄H₉—, M represents an alkali metal such as Na, Li, K, or Ce, R¹ represents H—, CH₃—, C₂H₅—, n-C₃H₇—, CH₂═CHCH₂—, n-C₄H₉—, C₆H₅—, or C₆H₁₃—, R² represents —CH₂CH₂—, —CH₂CH₂CH₂—, —CH₂CH₂CH₂CH₂CH₂CH₂—, —CH₂CH₂SCH₂CH₂—, —CH₂CH₂NHCH₂CH₂CH₂—, —CH₂CH₂OCONHCH₂CH₂CH₂—, or —CH₂CH₂NHCONHCH₂CH₂CH₂, R³ represents —(CH₂CH₂)₂N—CH₂CH₂CH₂—, or —(CH₂CH₂)₂CHOCONHCH₂CH₂CH₂—, and n represents an integer from one to three].

2. The method of forming metal wiring according to claim 1, wherein electroless plating is performed by using the metal particles fixed to the base surface as a catalyst to thickly provide the same type of metal as that of the metal particles to form single-layer metal wiring.

3. The method of forming metal wiring according to claim 1, wherein electroless plating is performed by using the metal particles fixed to the base surface as a catalyst to thickly provide a different type of metal from that of the metal particles to form metal wiring.

4. The method of forming metal wiring according to claim 1, wherein single-layer metal wiring is formed only from the metal particles fixed to the base surface by using the metal particles having a particle diameter of 100 nm to 500 nm.

5. (canceled)

6. The method of forming metal wiring according to claim 1, further comprising forming a Self Assembled Monolayer (SAM film) on the base surface, and performing exposure to light or graphic-drawing with a mask having a pattern opening portion interposed to selectively decompose or remove the SAM film in a region corresponding to the pattern,
wherein the metal particles are fixed to the region in which the SAM film is removed to form patterned metal wiring.

7. The method of forming metal wiring according to claim 1, wherein the silanol group produced by hydrolyzing the ethoxysilane group or the methoxysilane group reacts with and bonds to a hydroxyl group and/or a carbonyl group on the base surface.

8. The method of forming metal wiring according to claim 1, wherein the base surface is a surface of a glass substrate, a resin substrate, a silicon substrate, or a ceramic substrate, or a surface of an interlayer insulating layer, an organic semiconductor layer, an inorganic semiconductor layer, or a gate insulating film.

9. The method of forming metal wiring according to claim 1, wherein the metal particles are formed from one selected from gold (Au), nickel (Ni), cobalt (Co), iron (Fe), copper (Cu), silver (Ag), rhodium (Rh), palladium (Pd), and platinum (Pt), or an alloy of two or more selected therefrom.

10. An electronic part comprising the metal wiring formed by the method according to claim 1.

11. The electronic part according to claim 10, wherein the electronic part is one of a circuit board, an inorganic transistor, an organic transistor, an organic EL element, an inorganic EL element, a capacitor, an inorganic solar battery, and an organic solar battery mounted in electronic equipment.
